(19) United States
(12) Patent Application Publication
(10) Pub. No.: US 2010/0238178 A1
(43) Pub. Date: Sep. 23, 2010

(54) INFORMATION PROCESSING APPARATUS, CONTROL DEVICE, AND PROGRAM

(75) Inventors: Takashi SAWAZAKI, Chufu-shi (JP); Yoshiyuki ONO, Hino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/647,924

(22) Filed: Dec. 28, 2009

(30) Foreign Application Priority Data
Mar. 23, 2009 (JP) 2009-070241

(51) Int. Cl. G06T 11/00

(52) U.S. Cl. 345/467

(57) ABSTRACT

An information processing apparatus includes: a command supplying unit which supplies a drawing command containing identification information used to identify each glyph and instructing drawing of the contour of the glyph; a contour drawing unit which acquires glyph data indicating the contour of the glyph identified by the identification information contained in the drawing command and writes image data, in which the contour indicated by the acquired glyph data is represented by gray scale values of plural pixels, in a memory, when the drawing command is supplied from the command supplying unit; and a storage unit which stores posture information specifying a posture of the contour indicated by the image data written in the memory. The command supplying unit supplies the drawing command containing no posture information to the contour drawing unit when the contour of the glyph is drawn with the posture specified by the posture information stored in the storage unit, and supplies the drawing command containing the posture information to the contour drawing unit, when the contour of the glyph is not drawn with the posture specified by the posture information stored in the storage unit. The contour drawing unit writes the image data indicating the contour with the posture specified by the posture information when the drawing command containing the posture information is supplied from the command supplying unit, and writes the image data indicating the contour with the posture specified by the posture information stored in the storage unit when the drawing command containing no posture information is supplied from the command supplying unit.

### BACKGROUND

1. Technical Field

The present invention relates to a technique for drawing an outline font.

2. Related Art

An outline font is used as a data format for expressing the shape of a glyph on a computer. The outline font is expressed by a collection of the coordinates and contour of a dot serving as a reference. JP-A-9-90930 discloses a technique in which data regarding outline fonts are broken up into constituent element units of characters, the constituent element units are stored, and the outline fonts of a character requested to be drawn are collected to draw the character. Moreover, the glyph expresses visualization of a character or expresses normalized abstraction of the size and design from the constituent elements of the character.

When a CPU (Central Processing Unit) gives a drawing command to a module drawing characters to execute the drawing operation, the drawing command contains at least glyph identification information and information on the drawn position of the glyph or the posture of the glyph. For example, when the plurality of glyphs is combined to draw the character style of a complex character or when the number of characters is numerous, an amount of information contained in the drawing command becomes increased.

### SUMMARY

An advantage of some aspects of the invention is that it provides a technique for reducing an amount of information contained in a command given to draw a character.

According to an aspect of the invention, there is provided an information processing apparatus including: a command supplying unit which supplies a drawing command containing identification information used to identify each glyph and instructing drawing of the contour of the glyph; a contour drawing unit which acquires glyph data indicating the contour of the glyph identified by the identification information contained in the drawing command and writes image data, in which the contour indicated by the acquired glyph data is represented by gray scale values of plural pixels, in a memory, when the drawing command is supplied from the command supplying unit; and a storage unit which stores posture information specifying a posture of the contour indicated by the image data written in the memory. The command supplying unit supplies the drawing command containing no posture information to the contour drawing unit when the contour of the glyph is drawn with the posture specified by the posture information stored in the storage unit, and supplies the drawing command containing the posture information to the contour drawing unit, when the contour of the glyph is not drawn with the posture specified by the posture information stored in the storage unit. The contour drawing unit writes the image data indicating the contour with the posture specified by the posture information when the drawing command containing the posture information is supplied from the command supplying unit, and writes the image data indicating the contour with the posture specified by the posture information stored in the storage unit when the drawing command containing no posture information is supplied from the command supplying unit. With such a configuration, it is possible to further reduce the amount of information contained in the command for drawing a character, compared to a known technique.

In the information processing apparatus according to the above aspect of the invention, the contour drawing unit may include a posture information rewriter which rewrites the posture information stored in the storage unit to posture information contained in the drawing command, when the image data indicating the contour is written with the posture specified by the posture information contained in the drawing command. With such a configuration, it is possible to rewrite the posture information of the storage unit to the posture information contained in the drawing command and write the image data for drawing the contour with the posture designated by the rewritten posture information.

In the information processing apparatus according to the above aspect of the invention, the storage unit may store position information specifying a position at which the contour indicated by the image data written in the memory is drawn. The command supplying unit may supply the drawing command having no position information when the contour of the glyph is drawn at the position specified by the position information stored in the storage unit, and may supply the drawing command containing the position information when the contour of the glyph is not drawn at the position specified by the position information stored in the storage unit. The contour drawing unit may write the image data so as to draw the contour at the position specified by the position information when the position information is contained in the drawing command, and may write the image data so as to draw the contour at the position specified by the position information stored in the storage unit when the position information is not contained in the drawing command. With such a configuration, it is possible to further reduce the amount of information contained in the command for drawing a character. In the information processing apparatus according to the above aspect of the invention, the contour drawing unit may include a position information rewriter which rewrites the position information stored in the storage unit to the position information contained in the drawing command, when the image data indicating the contour is written at the position specified by the position information contained in the drawing command. With such a configuration, it is possible to rewrite the position information of the storage unit to the position information contained in the drawing command and write the image data for drawing the contour with the position designated by the rewritten position information.

According to another aspect of the invention, there is provided a control device which supplies a drawing command, which contains identification information used to identify a glyph and instructs drawing of the contour of the glyph, to a font drawing device including a contour drawing unit which acquires glyph data indicating the contour of the glyph identified by the identification information contained in the drawing command and writes image data, in which the contour indicated by the acquired glyph data is represented by gray scale values of plural pixels, in a memory when the drawing command is supplied, and a storage unit which stores posture information specifying a posture of the contour of the glyph indicated by the image data written in the memory. The control device includes: a command supplying unit which supplies the drawing command containing no posture information to the contour drawing unit when the contour of the glyph is drawn with the posture specified by the posture information stored in the storage unit, and supplies the drawing command containing the posture information to the contour drawing unit when the contour of the glyph is not drawn with the posture specified by the posture information stored in the storage unit, in a case where the contour drawing unit writes the image data indicating the contour with the posture specified by the posture information when the drawing command containing the posture information is supplied, and writes the image data indicating the contour with the posture specified by the posture information stored in the storage unit when the drawing command containing no posture information is supplied. With such a configuration, it is possible to further reduce the amount of information contained in the command for drawing a character, compared to a known technique.

According to still another aspect of the invention, there is provided a program for a computer which supplies a drawing command, which contains identification information used to identify a glyph and instructs drawing of the contour of the glyph, to a font drawing device including a contour drawing unit which acquires glyph data indicating the contour of the glyph identified by the identification information contained in the drawing command and writes image data, in which the contour indicated by the acquired glyph data is represented by gray scale values of plural pixels, in a memory when the drawing command is supplied, and a storage unit which stores posture information specifying a posture of the contour of the glyph indicated by the image data written in the memory. The program causes the computer to function as a command supplying unit which supplies the drawing command containing no posture information to the contour drawing unit when the contour of the glyph is drawn with the posture specified by the posture information stored in the storage unit, and supplies the drawing command containing the posture information to the contour drawing unit when the contour of the glyph is not drawn with the posture specified by the posture information stored in the storage unit, in a case where the contour drawing unit writes the image data indicating the contour with the posture specified by the posture information when the drawing command containing the posture information is supplied, and writes the image data indicating the contour with the posture specified by the posture information stored in the storage unit when the drawing command containing no posture information is supplied. With such a configuration, it is possible to further reduce the amount of information contained in the command for drawing a character, compared to a known technique.

### BRIEF DESCRIPTION OF THE DRAWINGS

The invention will be described with reference to the accompanying drawings, wherein like numbers reference like elements.

FIG. 1 is a diagram illustrating the outer appearance of a display apparatus according to an embodiment of the invention.

FIG. 2 is a block diagram illustrating the configuration of the display apparatus according to the embodiment.

FIG. 3 is a block diagram illustrating the configuration of a font processor according to the embodiment.

FIGS. 4A and 4B are explanatory diagrams illustrating glyph data indicating the contour of a simple glyph.

FIGS. 5A and 5B are explanatory diagrams illustrating the glyph data indicating the contour of the simple glyph.

FIGS. 6A and 6B are explanatory diagrams illustrating the glyph data indicating the contour of the simple glyph.

FIGS. 7A and 7B are explanatory diagrams illustrating the glyph data indicating the contour of a complex glyph.

FIG. 8 is an explanatory diagram illustrating a relationship between an affine transform parameter and the posture of the contour.

FIGS. 9A and 9B are explanatory diagrams illustrating the glyph data indicating the contour of the complex glyph.

FIGS. 10A to 10E are explanatory diagrams illustrating a drawing method recommended in the True Type font.

FIG. 11 is a diagram illustrating the sequence of a “character drawing operation” executed by the display apparatus according to the embodiment.

FIG. 12 is a time chart illustrating a time-series transition of the operation of each module when the display apparatus executes the “character drawing operation” according to the embodiment.

FIG. 13 is a flowchart illustrating a “command generating operation” executed by the display apparatus according to the embodiment.

FIG. 14 is a time chart illustrating a time-series transition of the operations of modules when the display apparatus executes “the character drawing operation” according to a modification of the invention.

### DESCRIPTION OF EXEMPLARY EMBODIMENTS

### A. Configuration

### A-1. Configuration of Apparatus

First, the configuration of a display apparatus according to an embodiment of the invention will be described.

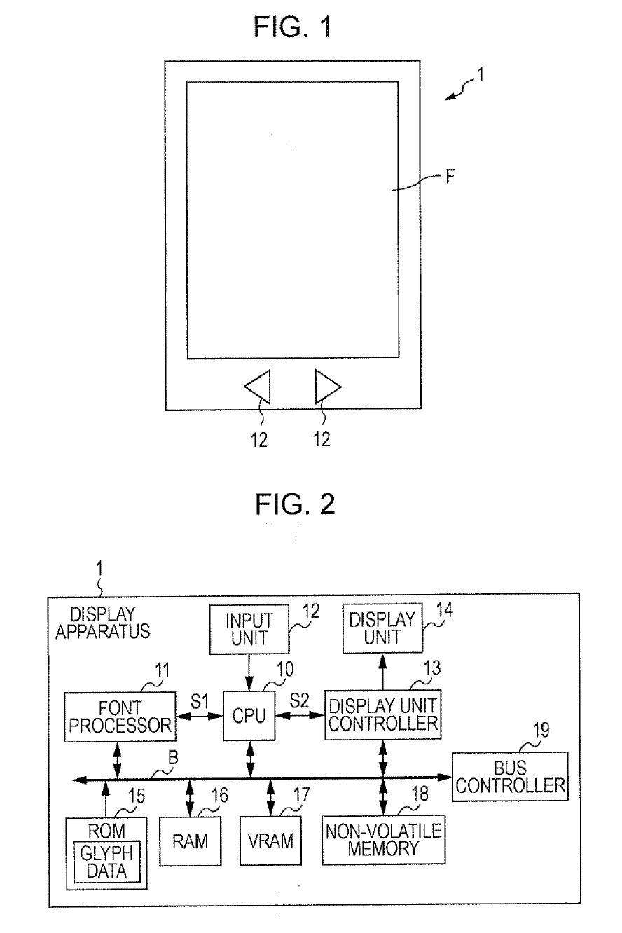

FIG. 1 is a diagram illustrating the outer appearance of a display apparatus 1 according to the embodiment. The display apparatus 1 is an example of an information processing apparatus according to the invention and a portable display apparatus called an electronic paper or the like. As shown in FIG. 1, operational keys of an input unit 12 and a display area F are disposed on the front surface of the display apparatus 1. The display area F is a rectangular display area. The display apparatus 1 displays an image on the display area F in response to an operation of the input unit 12 from a user.

FIG. 2 is a block diagram illustrating the configuration of the display apparatus 1.

As shown in FIG. 1, the display apparatus 1 includes a CPU 10, a font processor 11, a display unit controller 13, a ROM (Read-Only Memory) 15, a RAM (Random Access Memory) 16, a VRAM (Video RAM) 17, a non-volatile memory 18, and a bus controller 19, all of which are connected to each other through a bus B to transmit and receive data.

The CPU 10 is an example of a command supplying unit according to the invention. The CPU 10 reads a control program stored in the ROM 15 and loads the control program in the RAM 16 to execute an operation in accordance with a sequence described in the control program. The ROM 15 stores an OS (Operating System) executed by the CPU 10 or glyph data, which is data regarding an outline font, as well as the control program. The glyph data is data indicating the contour of a glyph. The RAM 16 is a storage unit which is used as a work area where the CPU 10 executes programs. The input unit 12 is an operation unit which is operated by the user. The input unit 12 includes an operational device such as a pen device or joystick. When the input unit 12 is operated by the user, the input unit 12 supplies an operation signal to the CPU 10 in response to this operation.

The CPU 10 generates “a drawing command” instructing the font process 11 to draw a character in response to the operation signal supplied from the input unit 12, and then supplies the generated drawing command to the font processor 11. The font processor 11 is an example of a contour drawing unit according to the invention and is formed by an LSI (Large Scale Integration), for example. The font processor 11 executes “a character drawing operation of drawing a character in accordance with the drawing command, when the drawing command is supplied from the CPU 10. In the character drawing operation, the font processor 11 reads and acquires glyph data corresponding to the drawing command from the ROM 15, analyzes the acquired glyph data, and converts the analyzed glyph data into image data with a bitmap format. The font processor 11 transmits the image data generated in the character drawing operation to the VRAM 17. The VRAM 17 may be configured so as to be included in a part of the RAM 16. The image data written in the VRAM 17 is supplied to the display unit controller 13 under the control of the CPU 10. The display unit controller 13 displays an image on the display area F by controlling a display unit 14. The display unit 14 is a display device which displays an image by a plurality of pixels using cholesteric liquid crystal or electrophoresis and has a so-called memory property capable of continuing displaying an image even though power supply is interrupted. The non-volatile memory 18 is a non-volatile storage unit such as a flash memory or a hard disk drive. The bus controller 19 executes adjusting so as not to give simultaneous access to modules connected inside.

A signal line S1 connects the CPU 10 to the font processor 11. The drawing command is supplied from the CPU 10 to the font processor 11 via the signal line S1. A signal (completion notifying signal) notifying completion of the drawing of a character is supplied from the font process 11 to the CPU 10 via the signal line S1. A signal line S2 connects the CPU 10 to the display unit controller 13. The CPU 10 instructs the display unit controller 13 to refresh the display unit 14 through the signal line S2 at refresh time of an image or the like. When the display unit 14 has a non-memory property, the display unit controller 13 drives the display unit 14. Therefore, the signal line S2 may not be provided.

When the display apparatus 1 is turned on, a reset operation is executed for each module. The CPU 10 activates a booting program stored in the ROM 15 to activate the OS. Thereafter, by executing control on the basis of the control program, the CPU 10 generates the drawing command in response to an operation of the input unit 12 from the user and causes the font processor 11 to execute the character drawing operation.

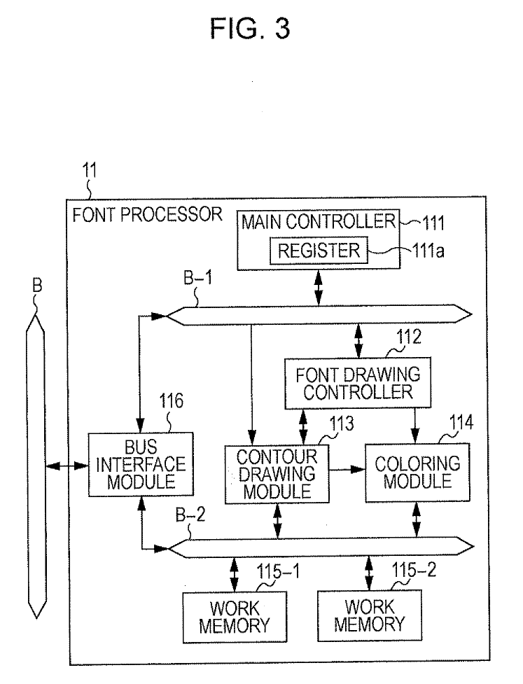

FIG. 3 is a block diagram illustrating the configuration of the font processor 11.

The main controller 111 includes a CPU or a register 111a and controls each section of the font processor 11. The register 111a is an example of a storage unit according to the invention and stores information which is contained in a drawing command and necessary in a font drawing operation.

A font drawing controller 112 causes a contour drawing module 113 and a coloring module 114 to execute a character drawing operation under the control of the main controller 111. Information contained in the drawing command and necessary for the font drawing operation includes information indicating “DrawChar” or “DrawCharFill”. The “DrawChar” is a command for executing an operation (hereinafter, referred to as a “contour drawing operation”) of drawing the contour of the glyph. The “DrawCharFill” is a command for executing the contour drawing operation and an operation (hereinafter, referred to as a “coloring drawing operation”) of coloring the inside of the contour.

The contour drawing module 113 is a module which draws the contour of the glyph by writing the contour of the glyph indicated by the glyph data in the format of bitmap data in a memory. The contour drawing module 113 executes the contour drawing operation of drawing the contour of the glyph, when the command “DrawChar” or the “DrawCharFill” is given to the main controller 111. Specifically, the contour drawing module 113 calculates the contour of the glyph on the basis of the glyph data acquired from the ROM 15 or the drawing command and calculates the position of pixels at which the contour of the glyph is drawn. The contour drawing module 113 writes the image data indicating the contour of the glyph in either a work memory 115-1 or 115-2 (hereinafter, referred to as the “work memory 115”, when it is not necessary to distinguish the work memories from each other). The contour drawing module 113 writes the image data indicating the contour of a first glyph in the work memory 115-1, and then writes the image data indicating the contour of a second glyph subsequent to the first glyph in the work memory 115-2.

The work memory 115 stores image data which is the image data indicating the contour of the glyph and expresses the gray scale values of pixels arranged two-dimensionally in a matrix shape. In the pixels arranged in two-dimensionally, it is assumed that coordinates (x, y) are assigned to each pixel in the orthogonal coordinate system in which one direction is determined as an x axis and the direction perpendicular to the X axis is determined as a Y axis. The coordinates of the origin are set to (0, 0). It is assumed that the image data indicating each pixel written in the VRAM 17 can correspond to the coordinate value of each pixel of the display unit 14. One of data (for example, a gray scale value “0”) indicating non-coloring and data (for example, a gray scale value “1”) indicating the coloring is written as a pixel unit in the work memory 115.

The coloring module 114 executes the coloring drawing operation, when the command “DrawCharFill” is given to the main controller 111. Specifically, the coloring module 114 reads the image data indicating the contour of the glyph from the work memory 115 and executes the coloring drawing operation on the inside of the contour of the glyph, that is, an area surrounded by the contour of the glyph drawn by the contour drawing module 113. A specific algorithm associated with the coloring is not described, since various algorithms are known. The font drawing controller 112 executes the contour drawing operation and the coloring drawing operation by alternately using the work memories 115-1 and 115-2. In this way, while the contour drawing module 113 executes the contour drawing operation, the coloring module 114 can execute the coloring drawing operation. Therefore, this parallel operation makes it possible to execute an operation associated with the drawing of a character at a higher speed. The coloring module 114 generates and outputs image data where a pixel and a background are combined, if necessary. Moreover, when the command “DrawChar” is given, the coloring module 114 does not execute the coloring drawing operation.

The bus interface module 116 inputs and outputs signals or data between the CPU 10, the ROM 15, the RAM 16, the VRAM 17, and the like via the bus B. Main buses B-1 and B-2 are transmission lines used to transmit data or signals in the font processor 11.

A signal line between the contour drawing module 113 and the coloring module 114 is used to notify the completion of the contour drawing operation. A signal line between the font drawing controller 112 and the coloring module 114 is used to transmit information on the bit width of the work memory 115, a range of data, or the like. A signal line between the coloring module 114 and the main bus B is used to transmit background data or the result of the coloring drawing operation.

### A-2. Configuration of Glyph Data

Next, the glyph data according to this embodiment will be described.

The glyph indicated by the glyph data stored in the ROM 15 forms the contour of one character or plural characters or the contour of a part of one character. The glyph is referred to as a “simple glyph”. On the other hand, when the shape of a glyph is complex, a glyph formed by combining a plurality of the simple glyphs is used. This glyph is referred to as a “complex glyph” for the simple glyph.

### A-2-1. Simple Glyph

First, the simple glyph according to this embodiment will be described.

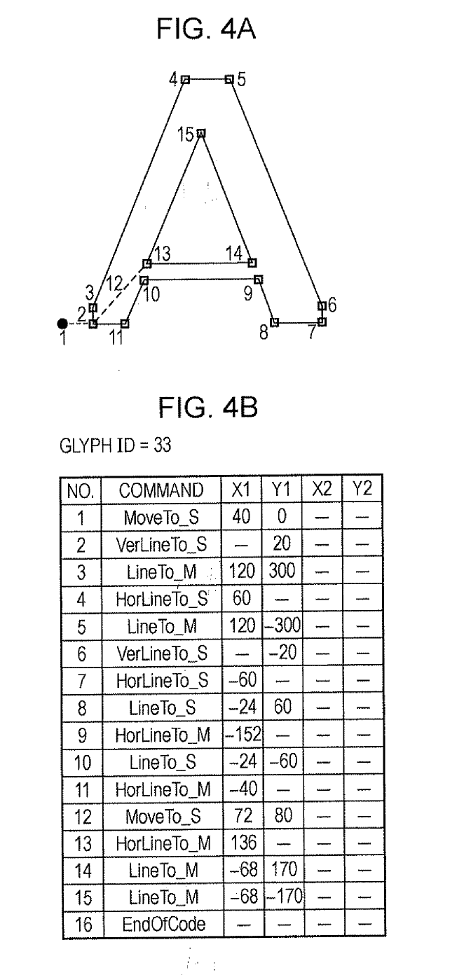

FIGS. 4A and 4B are explanatory diagrams illustrating the glyph data indicating the contour of the simple glyph of character “A”. FIG. 4A shows the figure of the glyph data. The glyph data is text data or binary data containing a command and the coordinates of a dot. FIG. 4B shows the data structure of the glyph data.

As shown in FIG. 4B, a glyph ID “33” as identification information used to identify the glyph is assigned to the glyph data corresponding to “A”. The glyph ID used to identify each glyph is assigned to the glyph data stored in the ROM 15. The glyph data contains information used to draw the contour of the glyph. Specifically, the glyph data contains the coordinates (X1, Y1) and (X2, Y2) of dots serving as information for specifying an end dot of the contour and a command drawing a straight line or a curved line serving as information for specifying a straight line or a curved line binding two end dots. Numerals “1” to “16” shown in FIG. 4A represent dots (control dots) on the contour of the glyph and correspond to commands distinguished by NO. 1 to NO. 16 shown in FIG. 4B.

As shown in FIG. 4B, the commands associated with the drawing of a character are described in the glyph data. A command “MoveTo” is a command for moving a dot position and contains the coordinates of a dot of a move destination as a parameter. A command “LineTo” is a command for drawing a straight line (line segment) and contains the coordinates of an end point of the straight line as a parameter. The command “LineTo” includes commands “HorLineTo” and “VerLineTo”. The command “HorLineTo” instructs drawing a straight line (line segment) extending in an X-axis direction. The command “VerLineTo” instructs drawing a straight line (line segment) extending in a Y-axis direction. In FIG. 4B, a suffix “_S” attached to the end of the command means that all parameters are 7 bits long or less, and a suffix “_M” attached to the end of the command means that all parameters are 10 bits long or less. A command “EndOfCode” is assigned to the last portion of the glyph data and defines the position of the end dot of a glyph.

Even though not used in FIGS. 4A and 4B, commands “Curve2” and “Curve3”, or the like may be provided in addition to the above-described commands. The command “Curve2” is a command for drawing a quadratic Bezier curve and contains the coordinates (“X1”, “Y1” in FIGS. 4A and 4B) of the end dot of a curve and the coordinates (“X2”, “Y2” in FIGS. 4A and 4B) of one control dot as parameters. The command “Curve3” is a command for drawing a cubic Bezier curve and contains the coordinates of the end dot of a curve and the coordinates of two control dots. The details of the commands may include at least the coordinates of a dot as information specifying an end dot of the contour and a command for drawing a straight line or a curved line binding two end dots.

The details of the glyph data shown in FIGS. 4A and 45 will be described in detail.

In FIG. 4A, dot “1” serves as a reference dot. The position of the reference dot is determined in advance for glyph data. By a command “MoveTo_S”, the position of a dot is moved from dot “1” to dot “2”. Since the command “MoveTo_S” contains the coordinates (40, 0) of an end dot of a straight line as a parameter, the position of the dot is moved by 40 pixels in the X-axis direction. Subsequently, by a command “VerLineTo_S”, a straight line extending from dot “2” to dot “3” in the Y-axis direction is drawn. Since the command “VerLineTo_S” contains the coordinates (−, 20) of an end dot of the straight line as a parameter, a line segment with a length of 20 pixels is drawn in the Y-axis direction. At this time, “- (hyphen)” means that there is no data and the details of the command are the same as that of “0”. Subsequently, by a command “LineTo_S”, a straight line (line segment) extending from dot “3” to dot “4” is drawn. Since the command “LineTo_S” contains the coordinates (120, 300) of an end dot of the straight line as a parameter, a line segment is drawn which has an end dot of the position moving by 120 pixels in the X-axis direction and by 300 pixels in the Y-axis direction and extends from dot “3” to dot “4”. Subsequently, as shown in FIG. 4A, the contour of the glyph is described on the basis of the glyph data in this manner.

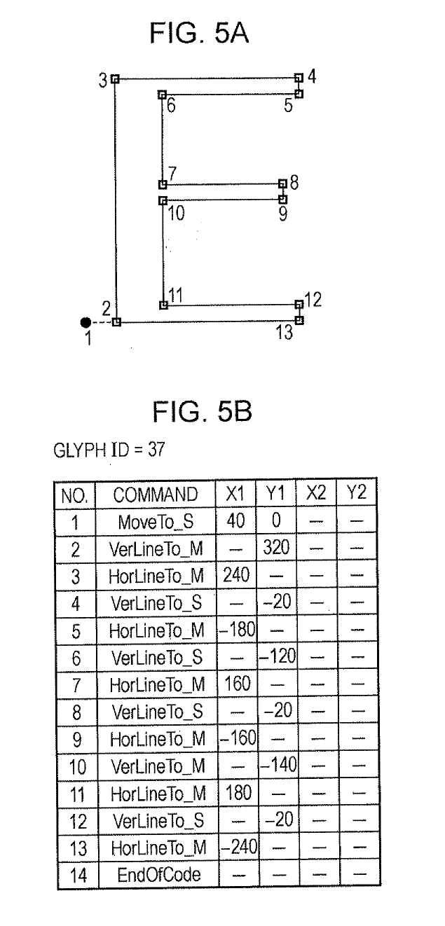

FIGS. 5A and 5B are explanatory diagrams illustrating the glyph data indicating the contour of the glyph of character “E”. FIG. 5A shows the figure of the glyph data. FIG. 5B shows the data structure of the glyph data.

As shown in FIGS. 5A and 5B, a glyph ID “37” is assigned to the glyph data corresponding to character “E”. As shown in FIG. 5B, the data structure of the glyph data is different from that of character “A” shown in FIGS. 4A and 4B in the details of the commands and the parameters. The contour of the glyph is described on the basis of the glyph data in the same way as the details of the above-described commands. Therefore, the explanation of the details of each command is omitted.

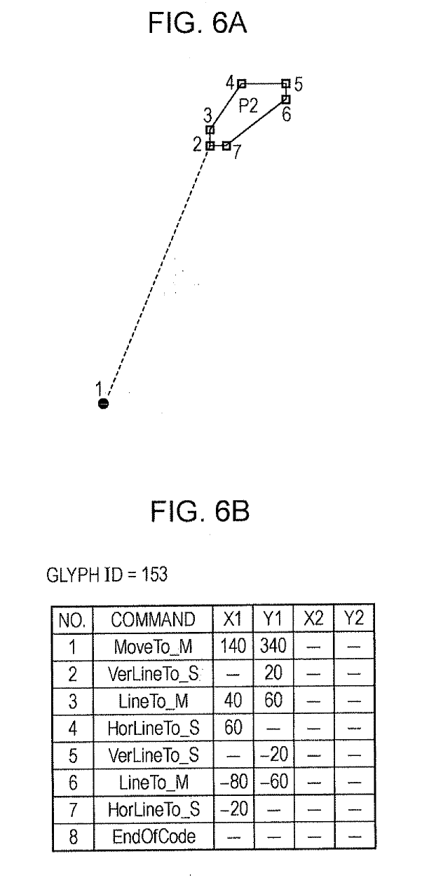

FIGS. 6A and 6B are explanatory diagrams illustrating the glyph data indicating the contour of the glyph data of accented pronunciation sign “∝”. FIG. 6A shows the figure of the glyph data. FIG. 6B shows the data structure of the glyph data. Accented pronunciation sign “′” is a sign representing an accented pronunciation put over vowels or the like of the French language.

As shown in FIGS. 6A and 6B, a glyph ID “153” is assigned to the glyph data corresponding to accented pronunciation sign “′”. As shown in FIG. 6B, the data structure of the glyph data is different from that of character “A” shown in FIGS. 4A and 4B or character “E” shown in FIGS. 5A and 5B in the details of the commands and the parameters. The contour of the glyph is described on the basis of the glyph data in the same way of the details of the above-described commands. Therefore, the explanation of the details of each command is omitted.

### A-2-2. Complex Glyph

Next, the complex glyph will be described.

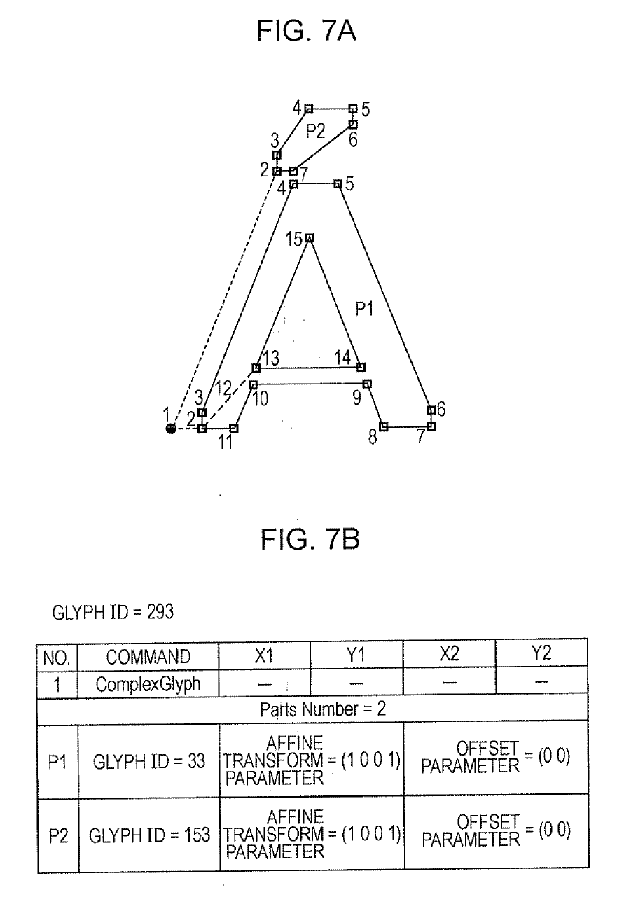

FIGS. 7A and 7B are explanatory diagrams illustrating the glyph data indicating the contour of a character (hereinafter, in the specification, referred to as “A′”) described by the complex glyph and formed by putting accented pronunciation sign “′” on the upper part of character “A”. FIG. 7A shows the figure of the glyph data. FIG. 7B shows the data structure of the glyph data.

As shown in FIG. 7B, glyph data ID “293” for identifying the glyph is assigned to the glyph data indicating the contour of the glyph of character “A′”. A glyph data ID for identifying each complex glyph is assigned to the complex glyph. The glyph data indicating the contour of the complex glyph contains the command “ComplexGlyph”, the command “Parts Number=2”, and the commands (here, the commands “P1” and “P2”) corresponding to the simple glyphs. The command “ComplexGlyph” indicates a complex glyph and indicates drawing a character by organizing a plurality of simple glyphs. The command “Parts Number=2” indicates description of the contour by organizing two simple glyphs. Parameters of this command are different depending on the number of combined simple glyphs. Here, the commands “P1” and “P2” corresponding to the glyphs of character “A” and accented pronunciation sign “′”, respectively, are contained as commands corresponding to the simple glyphs.

Next, the command “P1” and “P2” will be described. The common details thereof will first be described.

The commands “P1” and “22” each include a “glyph ID” of the simple glyph, an “affine transform parameter”, and an “offset parameter”. The glyph ID is a glyph ID assigned to the simple glyph and is information used to identify the simple glyph of which the glyph data is stored in the ROM 15. The affine transform parameter is an example of detailed information for specifying the posture of the contour according to the invention. The offset parameter represents a change amount of position of the contour from the reference dot and is an example of position information designating the position at which the contour is drawn according to the invention. The contour described on the basis of the glyph data indicating the contour of the complex glyph satisfies Expression 1 when the affine transform parameter and the offset parameter are used.

$$\begin{matrix}Expression 1 & \\ ( \begin{matrix}x \\ y\end{matrix} ) = ( \begin{matrix}A & B \\ D & E\end{matrix} ) ( \begin{matrix}{x}_{0} \\ {y}_{0}\end{matrix} ) + ( \begin{matrix}C \\ F\end{matrix} ) & ( 1 )\end{matrix}$$

In Expression 1, a 2-by-2 determinant (hereinafter, referred to as (A, B, D, E)) containing A, B, D, and E is the affine transform parameter. A 1-by-2 determinant (hereinafter, referred to as (C, F) containing C and F is the offset parameter. x0 and y0 are reference postures and indicate the coordinates of an X axis and a Y axis of each pixel in the work memory 115, respectively, when the contour is drawn on the basis of the glyph data without changing the posture of the contour. x and y indicate the coordinates of the X axis and the Y axis of each pixel in the work memory 115, respectively, when the posture is designated by the affine transform parameter and the drawing position is designated by the offset parameter to draw the contour. For example, when the posture of the contour drawn on the basis of the glyph data stored in the ROM 15 is not changed, a unit matrix (A, B, D, E)=(1, 0, 0, 1) is used as the affine transform parameter. When the position of the contour at which the contour is drawn is not changed from the reference dot, a zero matrix (C, F)=(0, 0) is used as the offset parameter. When the position of the contour is changed from the reference dot by “20” pixels in the X-axis direction and “−5” pixels in the Y-axis direction, a matrix (C, F)=(20, −5) is used as the offset parameter. In this way, the change amount of the position of the contour, at which the contour is drawn, from the reference dot is designated by the offset parameter.

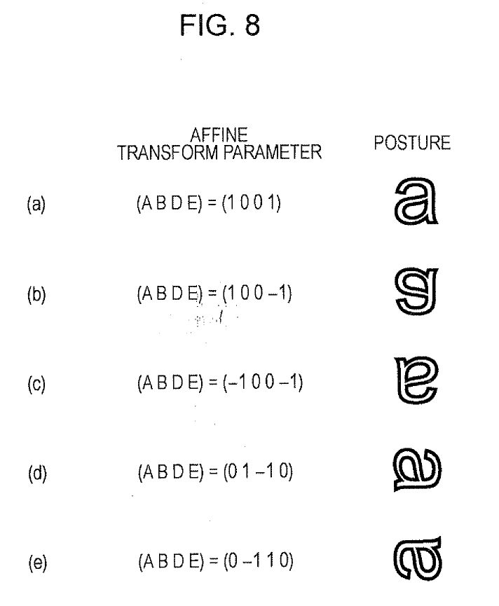

FIG. 8 is an explanatory diagram illustrating a relationship between the affine transform parameter and the posture of the contour indicated by the image data written in the work memory 115. Here, character “a” will be described as an example.

In part (a) of FIG. 8, in a case of (A, B, D, E)=(1, 0, 0, 1), the affine transform parameter represents that the contour indicated by the glyph data is not changed. In part (b) of FIG. 8, in a case of (A, B, D, E)=(1, 0, 0, −1), the affine transform parameter represents that the contour indicated by the glyph data is reversed in a vertical direction (reversed vertically). In part (C) of FIG. 8, in a case of (A, B, D, E)=(−1, 0, 0, −1), the affine transform parameter represents that the contour indicated by the glyph data is rotated clockwise by 180 degrees (that is, reversed vertically and horizontally). In part (d) of FIG. 8, in a case of (A, B, D, E)=(0, 1, −1, 0), the affine transform parameter represents that the contour indicated by the glyph data is rotated clockwise by 90 degrees. In part (e) of FIG. 8, a matrix (A, B, D, E)=(0, −1, 1, 0) is used, and the affine transform parameter represents that the contour indicated by the glyph data is rotated clockwise by 270 degrees. In addition to the affine transform parameters shown in FIG. 8, in a case of (A, B, D, E)=(0, 1, 1, 0), the affine transform parameter represents that the left upper portion and the right lower portion of the contour are reversed. Moreover, in a case of (A, B, D, E)=(0, 1, 1, 0), the affine transform parameter represents that the left lower portion and the right upper portion of the contour are reversed. In this way, the posture of the contour indicated by the image data written in the work memory 115 is designated depending on the value of the affine transform parameter. The above-described matrixes are just examples of the value of the affine transform parameter. A parameter for designating a character may be used in addition to the above matrixes.

Again referring to FIGS. 7A and 7B, the commands “P1” and “P2” will be described in more detail.

The command “P1” contains the glyph ID “33”, the affine transform parameter (A, B, D, E)=(1, 0, 0, 1), and the offset parameter (C, F)=(0, 0). The glyph data to which the glyph ID “33” is assigned indicates the contour of the glyph of character “A” shown in FIGS. 4A and 4B. In the command “P1”, the affine transform parameter (A, B, D, E)=(1, 0, 0, 1), and the offset parameter (C, F)=(0, 0) are designated. That is, the command “P1” represents that the posture of character “A” is not changed and the position at which the contour is drawn is not changed from the reference dot. The command “P2” contains the glyph ID “153”, the affine transform parameter (A, B, D, E)=(1, 0, 0, 1), and the offset parameter (C, F)=(0, 0). The glyph data to which the glyph ID “153” is assigned indicates the contour of the glyph of accented pronunciation sign “′” shown in FIGS. 6A and 65. In the command “P2”, the affine transform parameter (A, B, D, E)=(1, 0, 0, 1) and the offset parameter (C, F)=(0, 0) are designated. That is, the command “P2” represents that the posture of accented pronunciation sign “′” is not changed and the position at which the contour is drawn is not changed from the reference dot.

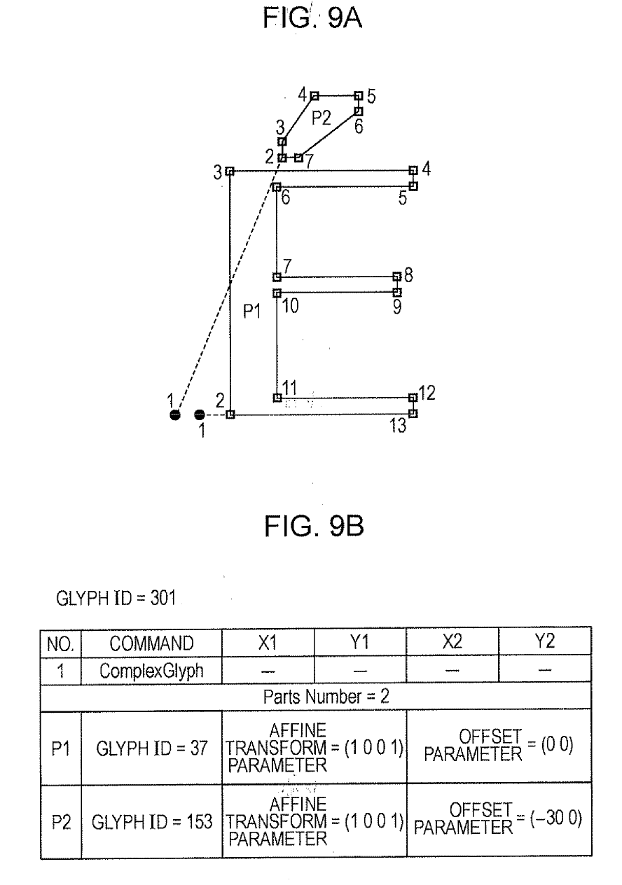

FIGS. 9A and 9B are explanatory diagrams illustrating glyph data of a character (in the specification, hereinafter, referred to as “E′”) formed by putting accented pronunciation sign “′” on the upper portion of character “E” of which the contour is described by the complex glyph. FIG. 9A shows the figure of the glyph data. FIG. 95 shows the data structure of the glyph data.

A glyph ID “301” is assigned to the glyph data corresponding to character “E′” and contains the command “ComplexGlyph” or the command “Parts Number=2”. Since the details of character “E′” are the same as those of character “A”, the explanation thereof is omitted.

The command “21” contains the glyph ID “37”, the affine transform parameter (A, B, D, E)=(1, 0, 0, 1), and the offset parameter (C, F)=(0, 0). The glyph data to which the glyph ID “37” is assigned indicates the contour of character “E” shown in FIGS. 5A and 5B. The command “21” contains the affine transform parameter (A, B, D, E)=(1, 0, 0, 1) and the offset parameter (C, F)=(0, 0). That is, the command “21” represents that the posture of character “E” is not changed and the position at which the contour is drawn is not changed from the reference dot. The command “22” contains the glyph ID “153”, the affine transform parameter (A, B, D, E)=(1, 0, 0, 1), and the offset parameter (C, F)=(0, −30). The glyph data to which the glyph ID “33” is assigned indicates the contour of the glyph of accented pronunciation sign “′” shown in FIGS. 6A and 6B. In the command “22”, the affine transform parameter (A, B, D, E)=(1, 0, 0, 1) and the offset parameter (C, F)=(−30, 0) are designated. That is, the command “22” represents that the posture of accented pronunciation sign, “′” is not changed and the position at which the contour is drawn is changed by “−30” pixels in the X-axis direction from the reference dot.

Glyph data in which three or more simple glyphs are combined may be used. In this case, in the glyph data, the parameters of the command “Parts Number” or the number of commands corresponding to the simple glyphs are different, and the glyph data has a data structure corresponding to the above-described details.

### A-3. Font Drawing Method

Next, a font drawing method according to this embodiment will be described.

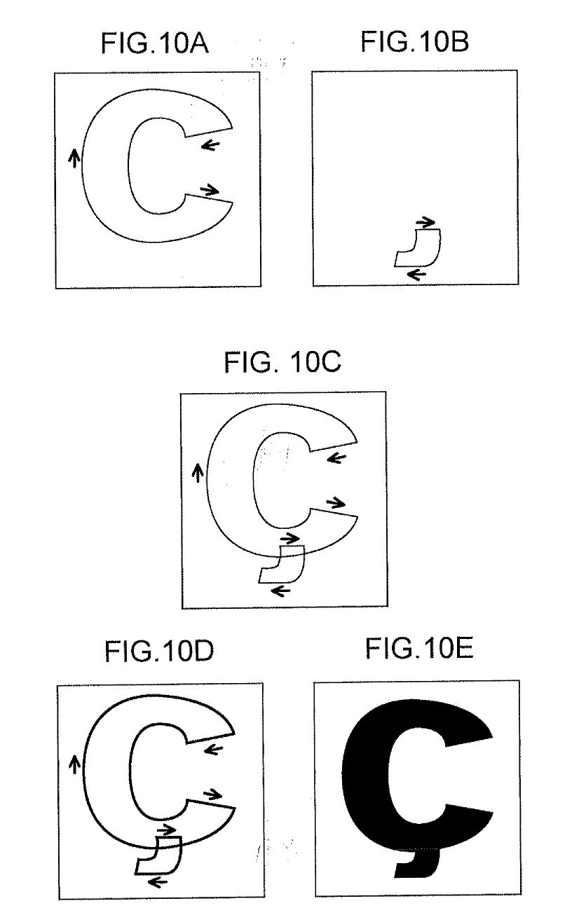

FIGS. 10A to 10F are explanatory diagrams illustrating a drawing method recommended in the True Type fonts. Here, an example where image data indicating the contour of a complex glyph is generated by combining two simple glyphs A and B will be described. First, the glyph data (see FIGS. 10A and 10B) of the simple glyphs A and B stored in the ROM 15 are combined in the work memory 115 (see FIG. 10C). In this way, the glyph data of the complex glyph is stored in the work memory 115. Alternatively, when three or more simple glyphs are combined, the glyph data thereof are combined in the same way in the work memory 115. The figures are illustrated in FIGS. 10A and 10B for easy understanding, but what is stored in the memory is not bitmap data but the glyph data. Next, the coloring module 114 reads the data indicating the contour from the work memory 115 by using the glyph data of the complex glyph (see FIG. 10D), and then the coloring module 114 colors the inside of the contour (see FIG. 10E).

### B. Operation

Next, an operation executed by the display apparatus 1 according to this embodiment will be described.

### B-1. Character Drawing Operation

First, a character drawing operation will be described.

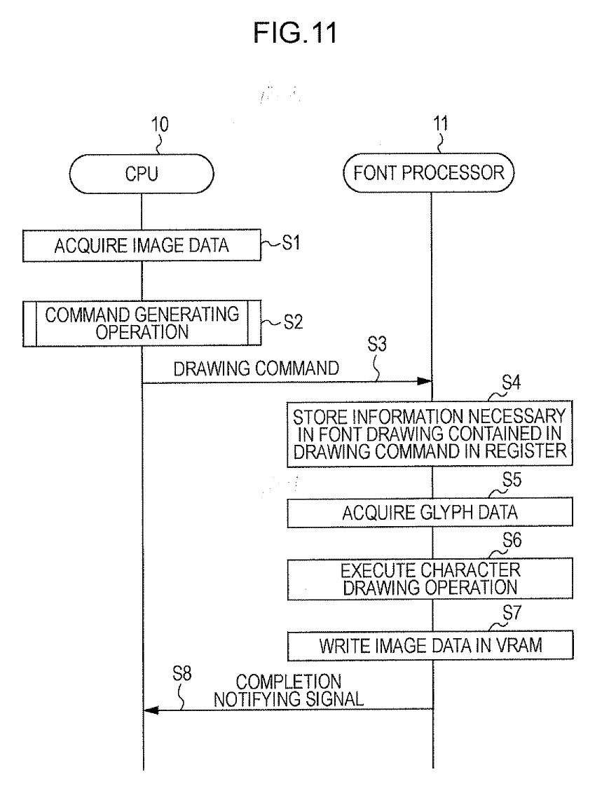

Here, an operation of drawing the contour using the complex glyphs shown in FIGS. 7A and 7B and FIGS. 9A and 9B will be described. FIG. 11 is a diagram illustrating the sequence of “the character drawing operation” executed by the display apparatus 1. The following operation is executed such that the CPU 10 executes an operation in accordance with the control program stored in the ROM 15.

First, when the input unit 12 is operated by the user and the CPU 10 receives an instruction to update the display details of the display unit 14, the CPU 10 reads and acquires image data corresponding to the updating from the non-volatile memory 18 (step S1). Then, the CPU 10 loads the image data on the RAM 16. The CPU 10 executes a “command generating operation” (step S2). The CPU 10 generates a drawing command containing the glyph ID used to identify each glyph and also containing the affine transform parameter or the offset parameter. The drawing command contains information indicating the command “DrawChar” or the command “DrawCharFill” or information on the data structure shown in FIGS. 7A and 7B or FIG. 9A or 9B in the case of the complex glyph. The details of the “command generating operation” are described in detail below.

The CPU 10 supplies the drawing command generated in the command generating operation to the font processor 11 (step S3). When the drawing command is supplied, the main controller 111 of the font processor 11 stores information, which is contained in the drawing command and is necessary in the font drawing operation, in the register 111a (step S4). At this time, the main controller 111 rewrites the details stored in the register 111a into the affine transform parameter and the offset parameter contained in the drawing command. That is, the main controller 111 is an example of a posture information rewriter and a position information rewriter according to the invention. Subsequently, the main controller 111 reads and acquires the glyph data, to which the glyph ID contained in the drawing command is assigned, from the ROM 15 (step S5). Subsequently, the main controller 111 executes the character drawing operation (step S6). In the character drawing operation, the main controller 111 executes the contour drawing operation of writing the image data indicating the contour in the work memory 115 on the basis of the glyph data, the affine transform parameter, and the offset parameter. The main controller 111 writes the image data indicating the contour in the work memory 115 so as to draw the contour with the posture designated by the affine transform parameter and at the position designated by the offset parameter.

When the character drawing operation is completed, the main controller 111 transmits the image data to the VRAM 17 and writes the image data in the VRAM 17 (step S7), and then supplies a completion notifying signal indicating the completion of the character drawing completion to the CPU 10 (step S8).

The “character drawing operation” has been described.

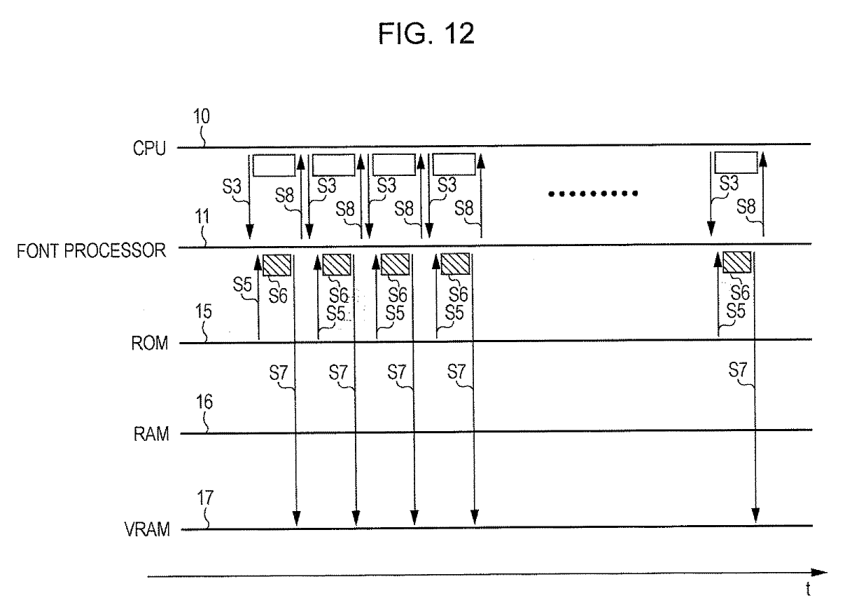

FIG. 12 is a time chart illustrating a time-series transition of the operation of each module when the display apparatus 1 executes the character drawing operation. In FIG. 12, the horizontal axis represents time t and time elapses in an arrow direction. S1 to S8 indicating arrows in FIG. 12 correspond to the steps in FIG. 11. Arrows between the modules represent a flow of the data generated in the execution of the steps. When the CPU 10 supplies the drawing command to the font processor 11, the font processor 11 executes the character drawing operation, the CPU 10 receives the completion notifying signal, and the CPU 10 generates the subsequent drawing command and supplies the subsequent drawing command to the font processor 11. In this way, the CPU 10 repeatedly generates and supplies the drawing command for drawing a character.

### B-2. Command Generating Operation

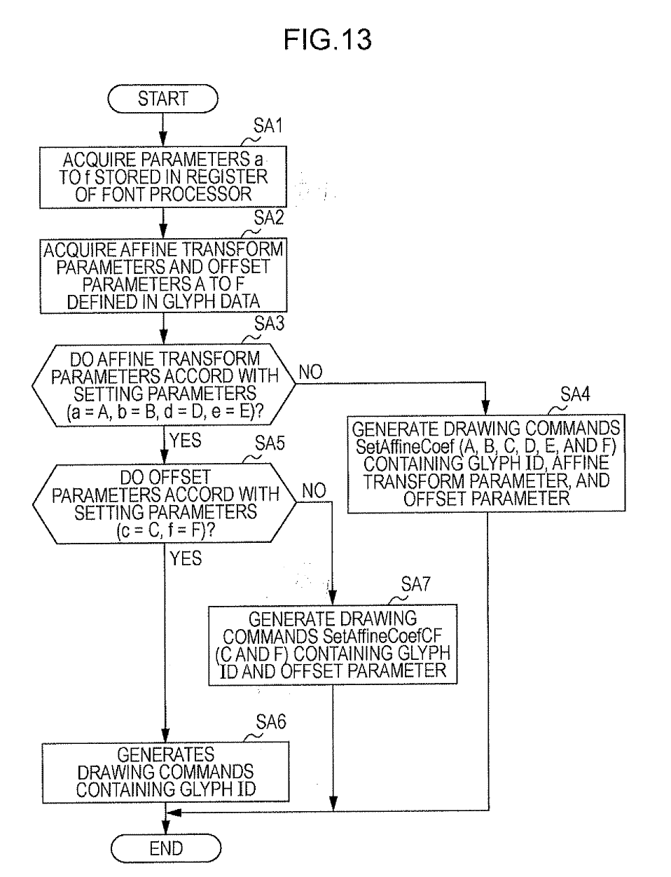

Next, the “command generating operation” will be described. Here, an operation will be described in which the display apparatus 1 continuously draws character “A′” and character “E′” by using the glyph data indicating the contours of the complex glyphs. FIG. 13 is a flowchart illustrating the “command generating operation” executed by the CPU 10.

When character “A′” is drawn, the CPU 10 generates the drawing command for drawing character “A” and supplies the generated drawing command to the font processor 11. When the character drawing operation is executed on the basis of the drawing command by the font processor 11, the CPU 10 continuously generates the drawing command for drawing the accented pronunciation sign “′” and supplies the generated drawing command. First, the CPU 10 generates the drawing command for drawing character “A”.

### B-2-1. First Command Generating Operation

First, the CPU 10 acquires setting parameters a to f (the affine transform parameters and the offset parameters) among information regarding to the drawing commands stored in the register 111a of the font processor 11 (step SA1). The parameters of A to F stored in the register 111a are generally referred to as “setting parameters” below. In order to distinguish the values of A to F contained in the drawing commands generated in the command generating operation by the CPU 10 from the values of A to F for the setting parameters, a, b, c, d, e, and f are used for the setting parameters, that is, alphabet lower case letters corresponding thereto are used. Here, it is assumed that the CPU 10 does not generate. a drawing command before character “A” and no setting parameter is stored in the register 111a.

Next, the CPU 10 acquires the affine transform parameter and the offset parameter defined for the glyph data of character “A”, which is a target of the character drawing operation (step SA2). Specifically, the CPU 10 acquires the glyph data corresponding to character “A′” shown in FIGS. 7A and 7B and acquires the parameters of A to F contained in the command “P1” from the ROM 15. That is, the CPU 10 acquires the parameters, that is, the affine transform parameter (A, B, D, E)=(1, 0, 0, 1) and the offset parameter (C, F)=(0, 0).

Subsequently, the CPU 10 determines whether the affine transform parameter acquired in step SA2 is identical with the setting parameter acquired in step SA1 (that is, whether conditions of A=a, B=b, D=d, and E=e are all satisfied) (step SA3). As described above, since the setting parameter is not acquired in step SA1, the CPU 10 now determines that the result is “NO”, and the operation proceeds to step SA4.

Then, the CPU 10 generates the drawing command, which contains the glyph ID “33” used to distinguish SetAffineCoef (1, 0, 0, 1, 0, 0) from the simple glyph “A”, as the drawing command for drawing character “A”. A command having a format of SetAffineCoef (A, B, C, D, F, F) is used when all of the parameters of A to F are supplied to the font processor 11. In other words, this command is generated when the CPU 10 does not draw the contour with the posture designated by the setting parameter stored in the register 111a and does not draw the contour at the position designated by the setting parameter. Here, when it is assumed that the parameters of A to F are 8-bit information, the total of the amount of information is 48 bits. Moreover, when the CPU 10 draws the contour on the basis of the glyph data indicating the contour of the complex glyph, the CPU 10 permits information such as the glyph ID (here, the glyph ID “293”) of the complex glyph, “ComplexGlyph”, or “Parts Number=2” to be contained in each drawing command. The CPU 10 also permits information such as “DrawChar” or “DrawCharFill” to be contained in the drawing command. Since these details are common to the drawing command described below, the explanation is omitted below. The CPU 10 supplies the drawing command generated in the command generating operation to the font processor 11 in step S3 shown in FIG. 11.

when the drawing command is supplied, the main controller 111 of the font processor 11 writes the information regarding the drawing command in the register 111a in the above-described way. Then, the main controller 111 executes the character drawing operation on the basis of the information regarding the drawing command. At this time, the main controller 111 stores the parameters A to F contained in the drawing command as the setting parameters in the register 111a (step S4 in FIG. 11). The main controller 111 keeps storing the setting parameter and deletes information regarding the drawing command other than the information corresponding to character “A”, when the character drawing operation of character “A” ends.

### B-2-2. Second Command Generating Operation

Next, the CPU 10 executes the command generating operation to generate the drawing command for drawing accented pronunciation sign “′” as a second drawing command.

The CPU 10 acquires the affine transform parameter and the offset parameter stored in the register 111a of the font process 11 as the setting parameters a to f from the main controller 111 (step SA1). Here, since the setting parameters, that is, the affine transform parameter (A, B, D, E)=(1, 0, 0, 1) and the offset parameter (C, F)=(0, 0) are stored in the register 111a, the CPU 10 acquires the setting parameters by the drawing command corresponding to character “A”. Subsequently, the CPU 10 acquires the affine transform parameter and the offset parameter defined in the glyph data from the glyph data in order to designate the posture of the contour of the glyph and the position, at which the contour is drawn, for accented pronunciation sign “′”, which is a target of the character drawing operation (step SA2). Here, the CPU 10 acquires the parameters, that is, the affine transform parameter (A, B, D, E)=(1, 0, 0, 1) and the offset parameter (c, f)=(0, 0) contained in the command “P2” shown in FIGS. 7A and 7B.

Subsequently, the CPU 10 determines whether the affine transform parameter acquired in step SA2 is identical with the setting parameter acquired in step SA1 (step SA3). Here, since conditions of A=a=1, B=b=0, D=d=0, and E=e=1 are satisfied, the CPU 10 determines that the result is “YES”, and then the operation proceeds to step SA5. Subsequently, the CPU 10 determines whether the offset parameter acquired in step SA2 is identical with the setting parameter acquired step SA1 (that is, whether the conditions of C=c and F=f are all satisfied) (step SA5). Here, since the conditions of C=c=0 and F=f=0 are satisfied, the CPU 10 determines that the result is “YES”, and then the operation proceeds to step SA6.

In this case, accented pronunciation sign “′” being drawn now and character “A” drawn first are drawn with the same posture and at the position at which the change amount from the reference dot is the same. At this time, the font processor 11 executes the character drawing operation on the affine transform parameter and the offset parameter by using the setting parameter stored in the register 111a. In this case, the CPU 10 generates and supplies the drawing command having no affine transform parameter and no offset parameter so as to draw the contour with the posture designated by the setting parameter stored in the register 111a and at the position designated by the setting parameter. The font processor 11 receiving the drawing command acquires the setting parameters a to f stored in the register 111a and executes the character drawing operations by using the affine transform parameter and the offset parameter for accented pronunciation sign “′”. In this way, the amount of information of the drawing command of accented pronunciation sign “′” is reduced by 6×8 bits=48 bits, compared to the case where the affine transform parameter and the offset parameter are contained.

Subsequently, the CPU 10 generates the drawing command for drawing character “E′”. In this case, the CPU 10 generates the drawing command for drawing character “E” and supplies the generated drawing command to the font processor 11. Continuously, the CPU 10 generates the drawing command for drawing accented pronunciation sign “′” and supplies the generated drawing command to the font processor 11.

### B-2-3. Third Command Generating Operation

The CPU 10 generates the drawing command for drawing character “E” as a third drawing command.

As shown in FIGS. 9A and 9B, the command “P1” of the glyph data corresponding to the complex glyph of character “E” contains the glyph ID “37”, the affine transform parameter (A, B, D, E)=(1, 0, 0, 1), and the offset parameter (C, F)=(0, 0). Accordingly, the CPU 10 sequentially executes steps SA1, SA2, SA3, SA5, and SA6 in the same way in which accented pronunciation sign “′” is drawn. The CPU 10 generates the drawing command which has no affine transform parameter, no offset parameter, and the glyph ID “37” and supplies the generated drawing command to the font processor 11.

### B-2-4. Fourth Command Generating Operation

When the font processor 11 executes the character drawing operation on character “E”, the CPU 10 generates the drawing command for drawing accented pronunciation sign “′” as a fourth drawing command. As for accented pronunciation sign “′”, as shown in FIGS. 9A and 9B, the command “P2” contains the glyph ID “153”, the affine transform parameter (A, B, D, E)=(1, 0, 0, 1), and the offset parameter (C, F)=(−30, 0). On the other hand, the setting parameters are (a, b, d, e)=(1, 0, 0, 1) and (c, f)=(−30, 0). Accordingly, since the affine transform parameter acquired in step SA2 is identical with the setting parameter acquired in step SA1, the CPU 10 determines that the result is “YES” in step SA3, and then the operation proceeds to step SA5. Subsequently, the CPU 10 determines whether the offset parameter acquired in step SA2 is identical with the setting parameter acquired in step SA1 (step SA5). Here, since the conditions of C≠c=−30 and F=f=0 are satisfied, the CPU 10 determines that the result is “NO”, and then the operation proceeds to step SA7.

In this case, character “E” drawn first and accented pronunciation sign “′” being drawn now are drawn with the same posture, but are different from each other in the change amount of position from the reference dot. The font processor 11 generates the drawing comma so as to draw the contour by using the setting parameter stored in the register 111a for the affine transform parameter and to draw the contour by using no setting parameter stored in the register 111a for the offset parameter. At this time, the CPU 10 generates the drawing command containing SetAffineCoefCF (−30, 0) and the glyph ID “153” used to identify accented pronunciation sign “′”, as the drawing command containing the offset parameter and no affine transform parameter corresponding to accented pronunciation sign “′”. The command with a format of SetAffineCoefCF (C, F) is used when the affine transform parameter is not supplied and the offset parameter is supplied to the font processor 11. In other words, this command refers to a drawing command generated when the CPU 10 draws the contour with the posture designated by the setting parameter stored in the register 111a and does not draw the contour at the position designated by the setting parameter. As described above, since the parameters of A to F each have 8 bits, the amount of information is reduced from 48 bits to 32 bits, compared to the case where the CPU 10 supplies all of the parameters of A to F.

In this way, whenever the CPU 10 supplies the drawing command, the CPU 10 executes the “command generating operation” and thus generates the drawing command so as not to contain the affine transform parameter and the offset parameter identical with the setting parameters stored in the register 111a.

The inventors found that a certain parameter is frequently used for the affine transform parameter or the offset parameter used by the font processor 11. Specifically, the posture of the contour of the glyph is not changed in most cases. That is, the affine transform parameter (A, B, D, E)=(1, 0, 0, 1) is overwhelmingly used. As for the offset parameter, the number of the offset parameters used to change the position at which the contour is drawn is relatively small and the number of the offset parameters (C, F)=(0, 0) is numerous. In consideration of this background, since the CPU 10 does not permit the frequently used parameter to be contained in the drawing command, it is possible to further reduce the amount of information involved in the drawing command compared with a known method.

### C. Modifications

The above-described embodiment may be modified as follows. Specifically, modification may be made as follows. These modifications may be combined in an appropriate method.

### C-1. Modification 1

In the above-described embodiment, when the affine transform parameter and the offset parameter are identical with the setting parameters, the CPU 10 does not permit both the affine transform parameter and the offset parameter to be contained in the drawing command. However, the offset parameter may be configured so as to be normally contained in the drawing command. In this case, the setting parameter may correspond to only the affine transform parameter. The CPU 10 may permit the affine transform parameter to be normally contained in the drawing command, and may not permit only the offset parameter to be contained in the drawing command when the offset parameter is identical with the setting parameter. In this case, the setting parameter may correspond to only the offset parameter. That is, when the CPU 10 supplies the drawing command which does not have at least one of the affine transform parameter and the offset parameter, it is possible to further reduce the amount of information contained in the drawing command, compared to the case where both of the affine transform parameter and the offset parameter are contained in the drawing command.

### C-2. Modification 2

In the above-described embodiment, when the font processor 11 draws the contour of the glyph by using the affine transform parameter or the offset parameter contained in the drawing command, the font processor 11 rewrites the setting parameters stored in the register 111a so as to set these parameters to new setting parameters. Accordingly, when the font processor 11 uses the parameters used in the character drawing operation executed immediately before, the amount of information of the drawing command is reduced. Instead of this configuration, the setting parameters may have a fixed value. For example, the affine transform parameter (A, B, D, E)=(1, 0, 0, 1) and the offset parameter (C, F)=(0, 0), which are frequently used in the above-described embodiment, may normally be set to the setting parameters, or other parameters may be set to the setting parameters. With such configuration, when the character is drawn using the parameter which is identical with the setting parameter determined in advance, the CPU 10 generates the drawing command which does not contain the identical parameter.

### C-3. Modification 3

In the above-described embodiment, the setting parameters are stored in the register 111a included in the font processor 11. Such a storage unit may be disposed in a unit other than the font processor 11. In the above-described embodiment, the CPU 10 acquires the setting parameters from the font processor 11, whenever the CPU 10 executes the command generating operation. However, the same details as the setting parameters may be stored in a memory included in the CPU 10 or the non-volatile memory 18 to acquire the setting parameters.

### C-4. Modification 4

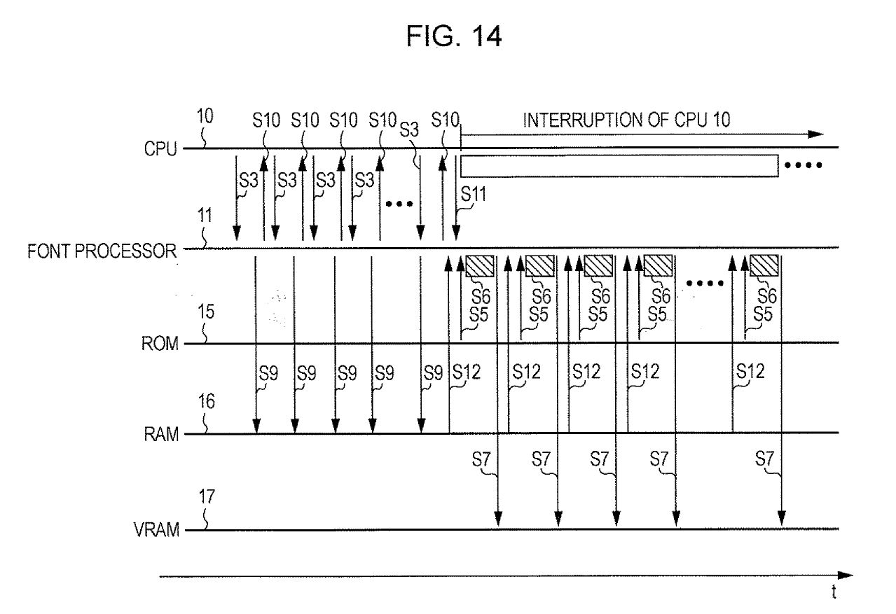

The command generating operation executed by the CPU 10 may be executed as follows. FIG. 14 is a time chart illustrating a time-series transition of the operations of modules when the display apparatus 1 executes the character drawing operation. In FIG. 14, the horizontal axis represents time t and time elapses in an arrow direction. Steps S1 to S8 shown in FIG. 14 correspond to the steps shown in FIG. 11.

In this example, the CPU 10 causes the font processor 11 to initiate the character drawing operation, after completing the command generating operation of generating the drawing command to display characters corresponding to one sheet (one page) of a display area F, for example, in process unit.

In this case, the CPU 10 supplies the drawing command generated in the command generating operation to the font processor 11 (step S3). The font processor 11 stores information, which is contained in the supplied drawing command and is necessary for the font drawing operation, in the RAM 16 (step S9). Subsequently, the font processor 11 supplies the CPU 10 with a storage completion signal indicating the storage of the drawing command (step S10). When the CPU 10 receives the storage completion signal, the CPU 10 generates the drawing command corresponding to a subsequent character and supplies the generated drawing command to the font processor 11. In this way, the display apparatus 1 repeatedly executes the steps of S3→S9→S10 to generate the drawing command one by one. Subsequently, the CPU 10 supplies an initial command to the font processor 11 to initiate the character drawing operation, when the command generating operation contained in the process unit is completed (step S11). When the font processor 11 receives the initial command, the font processor 11 reads and acquires information, which is contained in the drawing command and is necessary in the font drawing operation, from the RAM 16 (step S12), acquires the glyph data corresponding to the drawing command (step S5), and then executes the character drawing operation (step S6). Subsequently, the font processor 11 transmits the generated image data to the VRAM 17 (step S7). The font processor 11 repeats the steps of S12→S5→S6→S7 until the character drawing operation executed by the all of the drawing commands generated by the CPU 10 are completed. When the character drawing operation is completed, the font processor 11 supplies the completion notifying signal to the CPU 10.

After the CPU 10 generates all of the drawing commands contained in the process unit, the CPU 10 is not required to operate while the font processor 11 executes the drawing operation. Accordingly, by reducing the supply of power to the CPU 10 during this period, it is possible to obtain an advantage of reducing the power consumption of the entire display apparatus 1. Here, the CPU 10 supplies the drawing commands corresponding to the image data of a one-page image at one time. However, the CPU 10 may supply the plurality of drawing commands contained in the process unit.

### C-5. Modification 5

The hardware configuration of the display apparatus 1 is not limited to the configuration shown in FIG. 2. However, functions of generating the drawing commands described in the embodiment or drawing a character on the basis of the drawing commands may be realized. The information necessary in the font drawing operation may be determined appropriately in accordance with an apparatus drawing a character, as long as the details of the drawing command contains the glyph ID. The glyph ID may be an ID indicating the address of a storage area of the ROM 15 where the glyph data is stored or an ID identifying the glyph data acquired by the font processor 11.

In the above-described embodiment, the display apparatus 1 has been described as an example of the electronic paper. However, information processing apparatus such as a personal computer, a PDA (Personal Digital Assistant), or a portable phone other than the electronic paper may be used. In the above-described embodiment, the CPU 10 included in the display apparatus 1 has been used. However, the invention is not limited to the CPU 10 included in the display apparatus 1. The CPU may be realized by a computer apparatus (control apparatus) connected through communication means such as a USE (Universal Serial Bus) cable or a LAN (Local Area Network). In this case, the control apparatus acquires the setting parameters from a front processor (font drawing apparatus) serving as an external apparatus including a communication interface and executes the command generating operation to generate the drawing command. The control apparatus supplies the drawing command to the font drawing apparatus through the communication interface.

### C-6. Modification 6

In the above-described embodiment, the case where the character is drawn on the display unit 14 has been described. However, a configuration where an image is printed on a print sheet may be configured. That is, the display unit controller 13 according to the embodiment may be replaced by a print controller and the display unit 14 may be replaced by a printing unit. The print controller controls the printing unit to print an image on the print sheet. The printing unit prints the image on the print sheet in a thermal transfer method, an ink jet method, or the like. Specifically, when image data corresponding to an image printed on one print sheet is written in the VRAM 17 and the completion notifying signal is supplied, the CPU 10 transmits the image data written in the VRAM 17 to the printing unit and instructs printing of the image. The print controller causes the printing unit to print the image (character) indicated by the transmitted image data in response to this instruction.

In the above-described embodiment, “A”, “E”, “A′”, and “E” are used as the characters to be drawn. These “characters” may be hiragana, katakana, and kanji characters of Japanese or foreign characters such as an alphabet. Moreover, the characters may include signs such as “+” or “−” and figures such as yen or polygon. That is, the invention is applicable regardless of the character style (contour) of a character, as long as the contour of the character can be drawn on the basis of the glyph data.

### C-7. Modification 7

The program executed by the CPU 10 according to the embodiment may be supplied in a form in which the program is stored in a computer readable recording medium such as a magnetic recording medium (a magnetic tape, a magnetic disk (an HDD (Hard Disk Drive) or an FD (Flexible Disk)), or the like), an optical recording medium (an optical disk (CD (Compact Disk), a DVD (Digital Versatile Disk)), or the like), a magnetooptical recording medium, or a semiconductor memory (a flash ROM or the like). The program may be downloaded through a network such as the Internet.

What is claimed is:

1. An information processing apparatus comprising:
a command supplying unit which supplies a drawing command containing identification information used to identify each glyph and instructing drawing of the contour of the glyph;
a contour drawing unit which acquires glyph data indicating the contour of the glyph identified by the identification information contained in the drawing command and writes image data, in which the contour indicated by the acquired glyph data is represented by gray scale values of plural pixels, in a memory, when the drawing command is supplied from the command supplying unit; and
a storage unit which stores posture information specifying a posture of the contour indicated by the image data written in the memory,
wherein the command supplying unit supplies the drawing command containing no posture information to the contour drawing unit when the contour of the glyph is drawn with the posture specified by the posture information stored in the storage unit, and supplies the drawing command containing the posture information to the contour drawing unit, when the contour of the glyph is not drawn with the posture specified by the posture information stored in the storage unit, and
wherein the contour drawing unit writes the image data indicating the contour with the posture specified by the posture information when the drawing command containing the posture information is supplied from the command supplying unit, and writes the image data indicating the contour with the posture specified by the posture information stored in the storage unit when the drawing command containing no posture information is supplied from the command supplying unit.

2. The information processing apparatus according to claim 1, wherein the contour drawing unit includes a posture information rewriter which rewrites the posture information stored in the storage unit to posture information contained in the drawing command, when the image data indicating the contour with the posture specified by the posture information contained in the drawing command is written.

3. The information processing apparatus according to claim 1,
wherein the storage unit stores position information specifying a position at which the contour indicated by the image data written in the memory is drawn,
wherein the command supplying unit supplies the drawing command having no position information when the contour of the glyph is drawn at the position specified by the position information stored in the storage unit, and supplies the drawing command containing the position information when the contour of the glyph is not drawn at the position specified by the position information stored in the storage unit, and
wherein the contour drawing unit writes the image data so as to draw the contour at the position specified by the position information when the position information is contained in the drawing command, and writes the image data so as to draw the contour at the position specified by the position information stored in the storage unit when the position information is not contained in the drawing command.

4. The information processing apparatus according to claim 3, wherein the contour drawing unit includes a position information rewriter which rewrites the position information stored in the storage unit to the position information contained in the drawing command, when the image data indicating the contour is written at the position specified by the position information contained in the drawing command.

5. A control device which supplies a drawing command, which contains identification information used to identify a glyph and instructs drawing of the contour of the glyph, to a font drawing device including a contour drawing unit which acquires glyph data indicating the contour of the glyph identified by the identification information contained in the drawing command and writes image data, in which the contour indicated by the acquired glyph data is represented by gray scale values of plural pixels, in a memory when the drawing command is supplied, and a storage unit which stores posture information specifying a posture of the contour of the glyph indicated by the image data written in the memory, the control device comprising:
a command supplying unit which supplies the drawing command containing no posture information to the contour drawing unit when the contour of the glyph is drawn with the posture specified by the posture information stored in the storage unit, and supplies the drawing command containing the posture information to the contour drawing unit when the contour of the glyph is not drawn with the posture specified by the posture information stored in the storage unit, in a case where the contour drawing unit writes the image data indicating the contour with the posture specified by the posture information when the drawing command containing the posture information is supplied, and writes the image data indicating the contour with the posture specified by the posture information stored in the storage unit when the drawing command containing no posture information is supplied.

6. A program for a computer which supplies a drawing command, which contains identification information used to identify a glyph and instructs drawing of the contour of the glyph, to a font drawing device including a contour drawing unit which acquires glyph data indicating the contour of the glyph identified by the identification information contained in the drawing command and writes image data, in which the contour indicated by the acquired glyph data is represented by gray scale values of plural pixels, in a memory when the drawing command is supplied, and a storage unit which stores posture information specifying a posture of the contour of the glyph indicated by the image data written in the memory, the program causing the computer to function as a command supplying unit which supplies the drawing command containing no posture information to the contour drawing unit when the contour of the glyph is drawn with the posture specified by the posture information stored in the storage unit, and supplies the drawing command containing the posture information to the contour drawing unit when the contour of the glyph is not drawn with the posture specified by the posture information stored in the storage unit, in a case where the contour drawing unit writes the image data indicating the contour with the posture specified by the posture information when the drawing command containing the posture information is supplied, and writes the image data indicating the contour with the posture specified by the posture information stored in the storage unit when the drawing command containing no posture information is supplied.
